(19) United States
(12) Patent Application Publication
(10) Pub. No.: US 2006/0170123 A1
(43) Pub. Date: Aug. 3, 2006

(54) Reducing textile yarn production costs

(76) Inventor: Nicholas M. Masich, West Deptford, NJ (US)

Correspondence Address: Nicholas M. Masich, 316 Bowman Dr., Woodbury, NJ, 08096, US

(21) Appl. No.: 10/877,197

(22) Filed: Jun. 28, 2004

(51) Int. Cl. B29B 9/00

(52) U.S. Cl. 264/13

(57) ABSTRACT

This abstract describes eliminating the need for,cutting up manufactured synthetic filament polymer yarns (for examples, nylon and Kevlar) into wool and linen lengths and respinning these again into yarns approaching wool and linen like wear properties in clothing and other textiles at significant reductions in production costs accomplished by using laser pierced holes in the plates of and adding continuous wave or pulsed sonic generators to the rear of spinneret housings through which viscous polymer fluids flow both of which produce surface irregularities in the yarns (longitudinal and circumferential ridges in valleys) in the spun continuous filaments approaching wear properties of natural wool and linen.

### BRIEF SUMMARY OF THE INVENTION

This summary describes two improvements for manufacturing continuous synthetic filaments woven into yarns used in manufacturing clothing and other textiles thereby eliminating two steps in current production lines with significant reductions in production costs. Continuous synthetic filaments are improved through use of laser-pierced holes in spinnerets for presently used mechanical drilled holes to produce continuous synthetic filaments with surface irregularities producing yarns with wear qualities approaching those of linen and wool for clothing and other textiles. Use of continuous wave or pulsed sonic generators of optimum frequency in back of the spinneret housing also produce additional surface irregularities in the spun filaments with further increases in the wear properties in the yarns for clothing and other textiles.

### DETAILED DESCRIPTION OF INVENTION

In this invention I claim two improvements in present production lines for manufacturing continuous synthetic polymer filaments (for examples nylon and Kevlar) that are woven into yarns used in clothing and other textiles.

1. The first improvement uses spinnerets through which viscous fluids flow with smaller diameter holes made by tiny laser-beams replacing larger diameter mechanically drilled holes. The smaller diameter holes, being irregular in shape, similar to those made by a welding torch in steel, form continuous filaments with corresponding surface irregularities producing yarns with wear qualities approaching those of linen and wool for clothing and other textiles.

2. Insalling sonic generators of optimum frequency (continuous or pulsed) of very low amplitudes in the rear of the spinneret housings produces circumferential ridges and valleys in the spun filaments producing yarns with additional wear qualities approaching those of linen and wool in clothing and other textiles.

3. The above two production line improvements eliminate the need for cutting up presently manufactured polymer textile yarns into cotton and linen lengths and respinning these again at significant reductions in production costs. The above two claims also are the same as in my patent application number 20030155326, “Reducing tread separation in tires” dated Aug. 21, 2003 claiming improved yarns for tire cords extending tire life.
